(19) United States
(12) Patent Application Publication
(10) Pub. No.: US 2024/0294424 A1
(43) Pub. Date: Sep. 5, 2024

(54) METHODS OF ETCHING GLASS-BASED SHEETS

(71) Applicant: Corning Incorporated, Corning, NY (US)

(72) Inventors: ChaHyun Ku, Gumi-si (KR); ChihYuan Liao, ChuPei City (TW); Yu-Jiung Lin, New Taipei City (TW)

(21) Appl. No.: 18/572,916

(22) PCT Filed: Jun. 23, 2022
(86) PCT No.: PCT/US2022/034623

§ 371 Date: Dec. 21, 2023

Related U.S. Application Data
(60) Provisional application No. 63/217,400, filed on Jul. 1, 2021.

(51) Int. Cl. C03C 15/00

(52) U.S. Cl. CPC C03C 15/00

(57) ABSTRACT

Methods of etching a plurality of glass-based sheets comprise sorting a plurality glass-based sheets into a plurality of groups based on an average sheet thickness of a corresponding glass-based sheet. A maximum difference between a first average sheet thickness of a first sheet and a second average sheet thickness of a second sheet of a first group of the plurality of groups is less than or equal to a predefined threshold. Methods can further comprise sorting the first group into a plurality of sub-groups based on a total thickness variation. Methods of etching a glass-based sheet comprise placing the glass-based sheet in a jig, where a second edge is closer to the perimeter support than the first edge is to the perimeter support. Methods of etching a glass-based sheet comprise placing the glass-based sheet in a jig, where a first edge is closest to a top side of the jig.

### CROSS-REFERENCE TO RELATED APPLICATION

This application claims the benefit of priority under 35 U.S.C. § 119 of U.S. Provisional Application Ser. No. 63/217,400 filed on Jul. 1, 2021, the content of which is relied upon and incorporated herein by reference in its entirety.

### FIELD

The present disclosure relates generally to methods of etching glass-based sheets and, more particularly, to methods of etching glass-based sheets comprising batch etching a plurality of glass-based sheets.

### BACKGROUND

Glass-based sheets are commonly used, for example, in display devices, for example, liquid crystal displays (LCDs), electrophoretic displays (EPD), organic light emitting diode displays (OLEDs), plasma display panels (PDPs), or the like. Glass-based sheets can be formed by various glass forming techniques, including slot draw, float, down-draw, fusion down-draw, and up-draw. In some applications, it can be desirable to provide ultra-thin glass-based sheets having a thickness that is less than a thickness that can easily achieved by the various existing glass forming techniques. For examples, ultra-thin glass-based sheets can comprise a sheet thickness of about 300 micrometers (μm) or less, about 200 μm or less, about 100 μm or less, about 75 μm or less, about 50 μm or less, or about 30 μm or less.

It is known to produce glass-based sheets (e.g., ultra-thin glass-based sheets) by thinning glass-based sheets produced using conventional glass forming techniques. Existing techniques of thinning a glass-based sheet include etching, for example, using an acidic etchant.

There is a desire to improve the yield and throughput of methods of producing glass-based sheets using etching. Further, as demand increases for smaller spread of sheet thicknesses and lower thickness variation across a glass-based sheet, there is a desire to provide new methods of producing glass-based sheets having such properties.

### SUMMARY

There are set forth methods of etching a glass-based sheet and/or a plurality of glass-based sheets that can produce a high yield of glass-based sheets with low defects, low total thickness variation (TTV), and high uniformity in thickness across sheets of the plurality of glass-based sheets in a high-throughput, batch etching process. For example, sorting the plurality of sheets into groups and/or sub-groups based on average sheet thickness and/or TTV can increase yield and throughput because samples with similar initial average sheet thicknesses need to be etched a similar amount, meaning that a batch etching will produce a high yield of sheets comprising a final average sheet thickness within a predefined range and/or a final TTV within a second predefined range. Orienting at least one glass-based sheet so that a sub-average thickness of an edge (e.g., first edge or third edge) closest to the top side of the jig is greater than an another sub-average thickness of an another edge (e.g., second edge or fourth edge) opposite the edge can reduce a difference between these sub-average thicknesses and/or a TTV of the sheet in a vertical top spray etching process because the portion (e.g., edge) of the glass-based sheet closest to the top side of the jig can be etched faster than the another edge of the glass-based sheet. Placing an edge (e.g., fourth edge) of a glass-based sheet closer to a perimeter support (e.g., second side) than an another edge (e.g., third edge) of the based sheet is to the perimeter support (e.g., second side) with a sub-average thickness (e.g., fourth sub-average thickness) of the edge less than an another sub-average thickness (e.g., third sub-average thickness) of the another edge can reduce a difference between these sub-average thicknesses and/or a TTV of the sheet (e.g., in a vertical top spray etching process) because the edge closer to the perimeter support can be partially shielded from the etchant, which can reduce an effective etch rate of the corresponding edge of the glass-based sheet. Providing a low etch rate (e.g., about 3 micrometers per minute (μm/min) or less, about 2.5 μm/min or less, about 2 μm/min or less) can increase a yield of sheets relative to a higher etch rate because an incidence of defects can be reduced. Providing a sufficiently high etch rate (e.g., about 0.5 μm/min or more, about 1 μm or more) can increase a throughput of methods because glass-based sheet can be etched faster than if a lower etch rate was used without a significant increase in defects. Providing a vertical top spray etch process for etching (e.g., batch etching) the sheet(s) can increase an effective etch rate of an etchant, for example, by replacing existing etchant with new etchant by spraying the etchant and by removing existing etchant and/or etching byproduct through a flow of etchant in the direction of gravity along the sheet. Etching both major surfaces of the glass-based sheet (e.g., in vertical top spray etching) can increase throughput relative to single side etching by increasing (e.g., doubling) an effective etch rate. Etching both major surfaces of the glass-based sheet (e.g., in vertical top spray etching) can reduce (e.g., avoid) warp of the sheet during etching and/or in subsequent properties by removing substantially equal amounts of material from both major surfaces. Etching both major surfaces of the glass-based sheet (e.g., in vertical top spray etching) can produce a sheet with substantially uniform surface properties (e.g., composition) since material is removed from both side of the glass-based sheet (e.g., removing a surface layer that can comprise a different composition than a core layer).

Some example embodiments of the disclosure are described below with the understanding that any of the features of the various embodiments may be used alone or in combination with one another.

Embodiment 1. A method of etching a plurality of glass-based sheets comprises sorting the plurality of glass-based sheets into a plurality of groups of sheets based on an average sheet thickness of a corresponding glass-based sheet of the plurality of glass-based sheets. A maximum difference between a first average sheet thickness of a first sheet of a first plurality of sheets of a first group of sheets of the plurality of groups of sheets and a second average sheet thickness of a second sheet of the first plurality of sheets is less than or equal to a first predefined threshold. The first plurality of sheets comprises an initial overall average sheet thickness. The method comprises etching the first plurality of sheets in a batch etching process. After the etching, a maximum difference between a first final average sheet thickness of the first sheet and a second final average sheet thickness of the second sheet of the first plurality of sheets is less than or equal to the first predefined threshold. After the etching, the first plurality of sheets comprises a final overall average sheet thickness.

Embodiment 2. A method of etching a plurality of glass-based sheets comprises sorting the plurality of glass-based sheets into a plurality of groups of sheets based on an average sheet thickness of a corresponding glass-based sheet of the plurality of glass-based sheets. A maximum difference between a first average sheet thickness of a first sheet of a first plurality of sheets of a first group of sheets of the plurality of groups and a second average sheet thickness of a second sheet of the first plurality of sheets is less than or equal to a first predefined threshold. The method comprises sorting the first group of sheets into a plurality of sub-groups based on a total thickness variation (TTV) of a corresponding glass-based sheet of the first group. A maximum initial TTV of a first sub-group of the plurality of sub-groups is less than or equal to a second predefined threshold. The first plurality of sheets comprises an initial overall average sheet thickness. The method comprises etching the first sub-group in a batch etching process. After the etching, a maximum final TTV of the first sub-group is less than or equal to a third predefined threshold and a maximum difference between a first final average sheet thickness of a third sheet of the first sub-group and a second final average sheet thickness of a fourth sheet of the first sub-group is less than or equal to the first predefined threshold. After the etching, the first plurality of glass-based sheets comprises a final overall average sheet thickness.

Embodiment 3. The method of embodiment 2, wherein the maximum final TTV is about 10 micrometers (μm) or less.

Embodiment 4. The method of any one of embodiments 2-3, wherein the maximum final TTV is about 2 μm or less.

Embodiment 5. The method of any one of embodiments 1-4, wherein the final overall average sheet thickness is in a range from about 25 μm to about 250 μm.

Embodiment 6. The method of any one of embodiments 1-5, wherein the initial overall average sheet thickness is in a range from about 30 μm to about 1 millimeter (mm).

Embodiment 7. The method of any one of embodiments 1-6, wherein a difference between the initial overall average sheet thickness and the final overall average sheet thickness is about 50 μm or more.

Embodiment 8. The method of any one of embodiments 1-7, wherein an overall area of a first major surface of the first sheet is about 100 millimeters squared (mm²) or more.

Embodiment 9. The method of any one of embodiments 1-8, wherein an etch rate of the etching is in a range from about 1 micrometer per minute (μm/min) to about 3 μm/min.

Embodiment 10. The method of any one of embodiments 1-9, wherein the batch etching process comprises vertical top spray etching.

Embodiment 11. The method of embodiment 10, wherein the batch etching process comprises orienting each glass-based sheet relative to a corresponding jig comprising a perimeter support. For at least one glass-based sheet, the orienting comprises determining a first edge of the glass-based sheet comprising a first sub-average initial thickness greater than a corresponding sub-average initial thickness of other edges of the glass-based sheet comprising at least four edges, the first edge opposite a second edge of the at least four edges, and the placing the each glass-based sheet in the corresponding jig such that the first edge is closest to a top side of the corresponding jig.

Embodiment 12. The method of embodiment 11, wherein for the at least one glass-based sheet, the placing each glass-based sheet in the corresponding jig further comprises determining a third edge of the at least four edges of the glass-based sheet. The third edge comprising a third sub-average initial thickness greater than a fourth sub-average initial thickness of a fourth edge of the at least four edges. The method comprises either: (i) placing the glass-based sheet in the corresponding jig such that the fourth edge is closer to the perimeter support than the third edge is to the perimeter support if a difference between the third sub-average initial thickness and the fourth sub-average initial thickness is greater than a predefined thickness threshold; or (ii) placing the glass-based sheet in the corresponding jig such that the third edge is substantially the same distance from the perimeter support as the fourth edge is from the perimeter support if the difference between the third sub-average initial thickness and the fourth sub-average initial thickness is not greater than the predefined thickness threshold.

Embodiment 13. The method of embodiment 10, wherein the batch etching process comprises orienting each glass-based sheet relative to a corresponding jig comprising a perimeter support. For at least one glass-based sheet, the orienting comprises determining a first edge of the glass-based sheet comprising a first sub-average initial thickness greater than a corresponding sub-average initial thickness of other edges of the glass-based sheet comprising at least four edges. The first edge is opposite a second edge of the at least four edges. The method comprises determining a third edge of the at least four edges of the glass-based sheet comprising a third sub-average initial thickness greater than a fourth sub-average initial thickness of a fourth edge of the at least four edges. The placing of each glass-based sheet in the corresponding jig is such that the third edge is closest to a top side of the corresponding jig and the second edge is closer to the perimeter support than the first edge is to the perimeter support.

Embodiment 14. The method of any one of embodiments 12-13, wherein a difference between the third sub-average initial thickness and the fourth sub-average initial thickness is greater than a difference between a third sub-average final thickness of the third edge and the fourth sub-average initial thickness of the fourth edge for the at least one glass-based sheet.

Embodiment 15. The method of any one of embodiments 11-14, wherein a final total thickness variation (TTV) is less than an initial TTV for the at least one glass-based sheet.

Embodiment 16. The method of any one of embodiments 11-15, wherein a difference between the first sub-average initial thickness and a second sub-average initial thickness of the second edge is greater than a difference between a first sub-average final thickness of the first edge and a second sub-average final thickness of the second edge for the at least one glass-based sheet.

Embodiment 17. A method of etching a glass-based sheet comprising at least four edges between a first major surface and a second major surface comprises determining a first edge of the at least four edges of the glass-based sheet comprising a first sub-average initial thickness greater than a corresponding sub-average initial thickness of other edges of the at least four edges. The first edge is opposite a second edge of the at least four edges. The method comprises placing the glass-based sheet in a jig comprising a perimeter support. The first edge is closest to a top side of the jig. The method comprises etching the glass-based sheet in a vertical top spray etching process to reduce an initial average sheet thickness of the glass-based sheet to a final average sheet thickness.

Embodiment 18. A method of etching a glass-based sheet comprising at least four edges between a first major surface and a second major surface comprises determining a first edge of the at least four edges of the glass-based sheet comprising a first sub-average initial thickness greater than a corresponding sub-average initial thickness of other edges of the at least four edges. The first edge is opposite a second edge of the at least four edges. The method comprises placing the glass-based sheet in a jig comprising a perimeter support. The second edge is closer to the perimeter support than the first edge is to the perimeter support. The method comprises etching the glass-based sheet in a vertical top spray etching process to reduce an initial average sheet thickness of the glass-based sheet to a final average sheet thickness.

Embodiment 19. The method of embodiment 18, further comprising determining a third edge of the at least four edges of the glass-based sheet comprising a third sub-average initial thickness greater than a fourth sub-average initial thickness of a fourth edge of the at least four edges. The placing the glass-based sheet in the jig further comprises placing the third edge closest to a top side of the jig.

Embodiment 20. The method of embodiment 19, wherein a difference between the third sub-average initial thickness and the fourth sub-average initial thickness is greater than a difference between a third sub-average final thickness of the third edge and a fourth sub-average final thickness of the fourth edge.

Embodiment 21. The method of any one of embodiments 17-20, wherein a final total thickness variation (TTV) is less than an initial TTV.

Embodiment 22. The method of any one of embodiments 17-21, wherein a difference between the first sub-average initial thickness and a second sub-average initial thickness of the second edge is greater than a difference between a first sub-average final thickness of the first edge and a second sub-average final thickness of the second edge.

Embodiment 23. The method of any one of embodiments 17-22, wherein a maximum final TTV of the glass-based sheet is about 2 μm or less.

Embodiment 24. The method of any one of embodiments 17-23, wherein the final average sheet thickness is in a range from about 25 μm to about 250 μm.

Embodiment 25. The method of any one of embodiments 17-24, wherein the initial average sheet thickness is in a range from about 30 μm to about 1 mm.

Embodiment 26. The method of any one of embodiments 17-25, wherein a difference between the initial average sheet thickness and the final average sheet thickness is about 50 μm or more.

Embodiment 27. The method of any one of embodiments 17-26, wherein an overall area of the first major surface of the glass-based sheet is about 100 mm² or more.

### BRIEF DESCRIPTION OF THE DRAWINGS

The above and other features and advantages of embodiments of the present disclosure are better understood when the following detailed description is read with reference to the accompanying drawings, in which:

FIG. 1 is a flow chart illustrating example methods of etching glass-based sheets in accordance with embodiments of the disclosure;

FIGS. 2-8 schematically illustrate steps in a method of etching glass-based sheets in accordance with the embodiments of the disclosure;

FIG. 9 is a schematic plan view of an example consumer electronic device according to some embodiments; and

FIG. 10 is a schematic perspective view of the example consumer electronic device of FIG. 9.

Throughout the disclosure, the drawings are used to emphasize certain aspects. As such, it should not be assumed that the relative size of different regions, portions, and sheets shown in the drawings are proportional to its actual relative size, unless explicitly indicated otherwise.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, claims may encompass many different aspects of various embodiments and should not be construed as limited to the embodiments set forth herein. Unless otherwise noted, a discussion of features of embodiments of one foldable apparatus can apply equally to corresponding features of any embodiments of the disclosure. For example, identical part numbers throughout the disclosure can indicate that, in some embodiments, the identified features are identical to one another and that the discussion of the identified feature of one embodiment, unless otherwise noted, can apply equally to the identified feature of any of the other embodiments of the disclosure.

Sheets produced from methods of the embodiments of the disclosure comprise a glass-based sheet 203 comprising a glass-based material. In some embodiments, the glass-based sheet can comprise a glass-based material having a pencil hardness of 8H or more, for example, 9H or more. As used herein, pencil hardness is measured using ASTM D 3363-20 with standard lead graded pencils. As used herein, “glass-based” includes both glasses and glass-ceramics, wherein glass-ceramics have one or more crystalline phases and an amorphous, residual glass phase. A glass-based material (e.g., glass-based sheet) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion-exchange of larger ions for smaller ions in the surface of the sheet, as discussed below. However, other strengthening methods, for example, thermal tempering, or utilizing a mismatch of the coefficient of thermal expansion between portions of the sheet to create compressive stress and central tension regions, may be utilized to form strengthened sheets. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In one or more embodiments, a glass-based material may comprise, in mole percent (mol %): SiO₂ in a range from about 40 mol % to about 80%, Al₂O₃ in a range from about 5 mol % to about 30 mol %, B₂O₃ in a range from 0 mol % to about 10 mol %, ZrO₂ in a range from 0 mol % to about 5 mol %, P₂O₅ in a range from 0 mol % to about 15 mol %, TiO₂ in a range from 0 mol % to about 2 mol %, R₂O in a range from 0 mol % to about 20 mol %, and RO in a range from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In some embodiments, a glass-based sheets may optionally further comprise in a range from 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. “Glass-ceramics” include materials produced through controlled crystallization of glass. In some embodiments, glass-ceramics have about 1% to about 99% crystallinity. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including ß-quartz solid solution, ß-spodumene, cordierite, petalite, and/or lithium disilicate. The glass-ceramic sheets may be strengthened using the chemical strengthening processes. In one or more embodiments, MAS-System glass-ceramic sheets may be strengthened in Li₂SO₄ molten salt, whereby an exchange of 2Li⁺ for Mg²⁺ can occur.

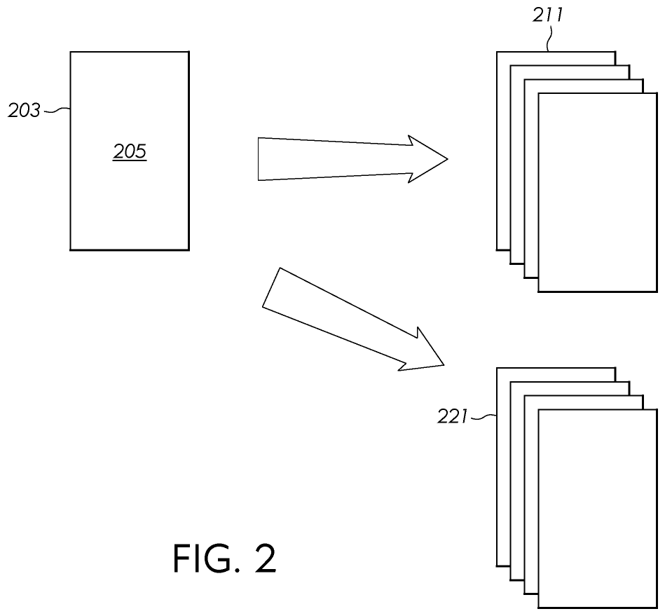

In some embodiments, as shown in FIGS. 2-4, the glass-based sheet 203 can comprise a first major surface 205. As used herein, an overall area of the glass-based sheet 203 can be an overall area of the first major surface 205. In further embodiments, an overall area of the glass-based sheet 203 can be about 50 millimeters squared (mm²) or more, about 100 mm² or more, about 140 mm² or more, about 170 mm² or more, about 250 mm² or more, about 3,000,000 mm² or less, about 300,000 mm² or less, about 30,000 or less, about 3,000 mm² or less, about 1,000 mm² or less, about 700 mm² or less, or about 400 mm² or less. In further embodiments, an overall area of the glass-based sheet can be in a range from about 50 mm² to about 3,000,000 mm², from about 100 mm² to about 3,000,000 mm², from about 100 mm² to about 300,000 mm², from about 100 mm² to about 30,000 mm², from about 140 mm² to about 30,000 mm², from about 140 mm² to about 3,000 mm², from about 140 mm² to about 1,000 mm², from about 170 mm² to about 1,000 mm², from about 170 mm² to about 700 mm², from about 250 mm² to about 700 mm², from about 250 mm² to about 400 mm², or any range or subrange therebetween.

In some embodiments, although not shown, the glass-based sheet can comprise a second major surface opposite the first major surface. As used herein, an average sheet thickness refers to an average distance between the first major surface and the second major surface over the overall area of the first major surface based on measurements at 80 locations evenly spaced over the first major surface. Throughout the disclosure, an initial average sheet thickness refers to an average sheet thickness of the glass-based sheet before being etched in methods of embodiments of the disclosure. Through the disclosure, a final average sheet thickness refers to an average sheet thickness of the glass-based sheet after being processed with methods of embodiments of the disclosure. In further embodiments, an initial average sheet thickness can be about 30 micrometers (μm) or more, about 50 μm or more, about 100 μm or more, about 200 μm or more, about 3 millimeters (mm) or less, about 1 mm or less, about 800 μm or less, or about 600 μm or less, or about 400 μm or less. In further embodiments, an initial average sheet thickness can be in a range from about 30 μm to about 3 mm, from about 30 μm to about 1 mm, from about 50 mm to about 1 mm, from about 50 μm to about 800 μm, from about 100 μm to about 800 μm, from about 100 μm to about 600 μm, from about 200 μm to about 600 μm, from about 200 μm to about 400 μm, or any range or subrange therebetween. In further embodiments, a final average sheet thickness can be about 20 μm or more, about 25 μm or more, about 30 μm or more, about 40 μm or more, about 50 μm or more, about 250 μm or less, about 150 μm or less, about 100 μm or less, about 80 μm or less, or about 60 μm or less. In further embodiments, a final average sheet thickness can be in a range from about 20 μm to about 250 μm, from about 25 μm to about 250 μm, from about 30 μm to about 250 μm, from about 30 μm to about 150 μm, from about 40 μm to about 150 μm, from about 40 μm to about 100 μm, from about 50 μm to about 100 μm, from about 50 μm to about 80 μm, or any range or subrange therebetween.

As used herein, a total thickness variation (TTV) of a sheet of glass-based material refers to a difference between a maximum sheet thickness and a minimum sheet thickness, wherein the sheet thickness is measured at 80 locations evenly spaced over the first major surface of the glass-based sheet. Through the disclosure, an initial TTV refers to a TTV of the glass-based sheet before being etched in methods of embodiments of the disclosure. Through the disclosure, a final TTV refers to a TTV of the glass-based sheet after being processed with methods of embodiments of the disclosure. In some embodiment, the initial TTV and/or the final TTV can be about 0.5 μm or more, about 1 μm or more, about 1.5 μm or more, about 2 μm or more, about 3 μm or more, about 20 μm or less, about 10 μm or less, about 8 μm or less, or about 5 μm or less. In some embodiments, the initial TTV and/or the final TTV can be in a range from about 0.5 μm to about 20 μm, from about 1 μm to about 20 μm, from about 1 μm to about 10 μm, from about 1.5 μm to about 10 μm, from about 1.5 μm to about 8 μm, from about 2 μm to about 8 μm, from about 2 μm to about 5 μm, from about 3 μm to about 5 μm, or any range or subrange therebetween.

In some embodiments, the glass-based sheet can be optically transparent. As used herein, “optically transparent” or “optically clear” means an average transmittance of 70% or more in the wavelength range of 400 nm to 700 nm through a 1.0 mm thick piece of a material. In some embodiments, an “optically transparent material” or an “optically clear material” may have an average transmittance of 75% or more, 80% or more, 85% or more, or 90% or more, 92% or more, 94% or more, 96% or more in the wavelength range of 400 nm to 700 nm through a 1.0 mm thick piece of the material. The average transmittance in the wavelength range of 400 nm to 700 nm is calculated by measuring the transmittance of whole number wavelengths from about 400 nm to about 700 nm and averaging the measurements. Throughout the disclosure, a refractive index of a material is defined as the ratio between the speed of light in a vacuum and the speed of light in the corresponding material for light of a first wavelength. As used herein, the refractive index is measured in accordance with ASTM E1967-19, where the first wavelength comprises 589 nm. Without wishing to be bound by theory, a refractive index of the glass-based sheet can be determined using a ratio of a sine of a first angle to a sine of a second angle, where light of the first wavelength is incident from air on a surface of the glass-based sheet at the first angle and refracts at the surface of the glass-based sheet to propagate light within the optically clear adhesive at a second angle. In some embodiments, a refractive index of the glass-based sheet can be about 1.4 or more, about 1.45 or more, about 1.49 or more, about 1.6 or less, or about 1.55 or less. In some embodiments, the first refractive index of the glass-based sheet can be in a range from about 1.4 to about 1.6, from about 1.45 to about 1.55, from about 1.49 to about 1.55, or any range or subrange therebetween.

In some embodiments, the glass-based sheet etched using methods of the disclosure can be part of a consumer electronic device, for example, a consumer electronic product, a smartphone, a tablet, a wearable device, or a laptop. The consumer electronic product can comprise a front surface, a back surface and side surfaces. The consumer electronic product can further comprise electrical components at least partially within the housing. The electrical components can comprise a controller, a memory, and a display. The display can be at or adjacent to the front surface of the housing. The consumer electronic product can comprise a cover substrate disposed over the display. In some embodiments, at least one of a portion of the housing or the cover substrate comprises a glass-based sheet etched using the methods of the disclosure.

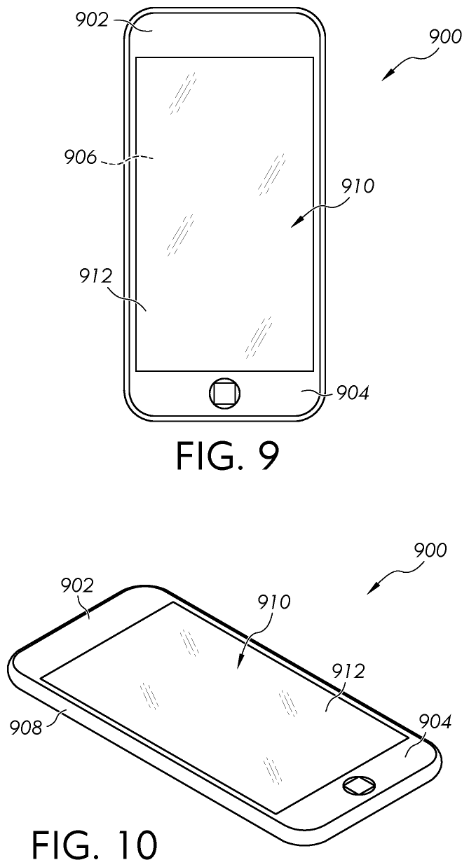

A glass-based sheet etched using the methods of the disclosure may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating a glass-based sheet etched using the methods of the disclosure is shown in FIGS. 9 and 10. Specifically, FIGS. 9 and 10 show a consumer electronic device 900 including a housing 902 having a front surface 904, a back surface 906, and side surfaces 908. The consumer electronic device 900 can comprise electrical components (not shown) that are at least partially inside or entirely within the housing and including at least a controller, a memory, and a display 910 at or adjacent to the front surface of the housing. The consumer electronic device 900 can comprise a cover substrate 912 at or over the front surface of the housing such that it is over the display. In some embodiments, at least one of the cover substrate 912 or a portion of housing 902 may include a glass-based sheet etched using the methods of the disclosure.

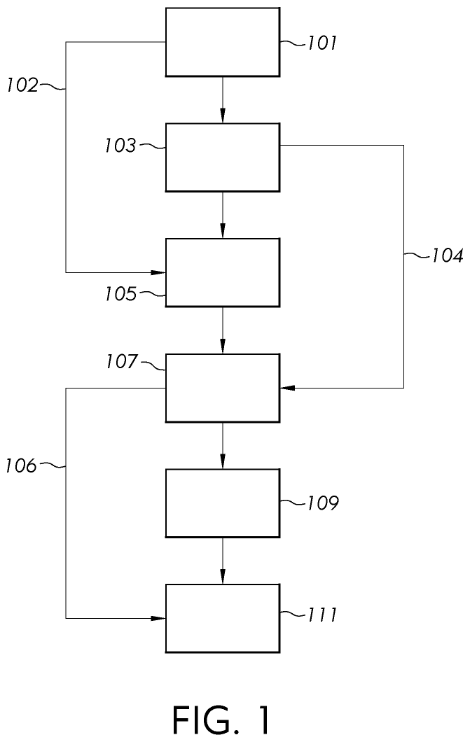

Embodiments of methods of making the glass-based sheet, in accordance with embodiments of the disclosure, will be discussed with reference to the flow chart in FIG. 1 and example method steps illustrated in FIGS. 2-8.

In a first step 101 of methods of the disclosure, methods can start with providing a glass-based sheet and/or a plurality of glass-based sheets. In some embodiments, the glass-based sheet and/or the plurality of glass-based sheets may be provided by purchase or otherwise obtaining a glass-based sheet(s) or by forming the glass-based sheet(s). In some embodiments, the glass-based sheet and/or the plurality of glass-based sheets can be formed with one or more of a variety of ribbon forming processes, for example, slot draw, down-draw, fusion down-draw, up-draw, press roll, redraw or float. In further embodiments, glass-based sheet(s) comprising ceramic crystals can be provided by heating a glass-based sheet to crystallize one or more ceramic crystals. In some embodiments, the glass-based sheet (e.g., a glass-based sheet of the plurality of glass-based sheets) can comprise an initial average sheet thickness within one or more of the ranges discussed above for the initial average sheet thickness. In some embodiments, the glass-based sheet (e.g., a glass-based sheet of the plurality of glass-based sheets) can comprise an initial TTV within one or more of the ranges discussed above for the initial TTV.

After step 101, in some embodiments as shown in FIG. 2, methods can comprise step 103 comprising sorting the plurality of glass-based sheets into a plurality of groups of sheets. As shown in FIG. 2, the glass-based sheet 203 of the plurality of glass-based sheets can be sorted into a first group 211 or a second group 221 based on criteria. In some embodiments, each sheet of the plurality of sheets can be sorted into the plurality of groups of sheets.

In some embodiments, the criteria for sorting a glass-based sheet (e.g., plurality of glass-based sheets) can be an initial average sheet thickness of the glass-based sheet. In further embodiments, the sorting based on the initial average sheet thickness can group glass-based sheets with similar initial average sheet thicknesses together. In even further embodiments, a first group comprising a first plurality of sheets that the glass-based sheet is sorted into can comprise a maximum difference between a first average sheet thickness of a first sheet of a first plurality of sheets of the first group of sheets and a second average sheet thickness of a second sheet of the first plurality of sheets is less than or equal to a predefined threshold. In still further embodiments, the predefined threshold can be about 5 μm or less, about 2 μm or less, about 1.5 μm or less, 1 μm or less, about 0.8 μm or less, or about 0.5 μm or less. In even further embodiments, the first group comprising the first plurality of sheets that the glass-based sheet is sorted into can comprise an initial overall average sheet thickness, which is an average of the initial average sheet thickness of each glass-based sheet in the first plurality of glass-based sheets. In still further embodiments, the overall initial average sheet thickness can be within one or more of the ranges discussed above for the initial average sheet thickness.

In further embodiments, the criteria for sorting a glass-based sheet can further comprise a TTV of the glass-based sheet. In even further embodiments, the first group of sheets can be sorted into a plurality of sub-groups based on the TTV of a corresponding glass-based sheet of the first group. In still further embodiments, a first sub-group of the plurality of sub-groups that the glass-based sheet is sorted into can comprise a maximum initial TTV equal to a maximum difference between a first TTV of a first sheet of a first sub-group and a second TTV of a second sheet of the first sub-group is less than or equal to a second predefined threshold. In further embodiments, the second threshold can be about 5 μm or less, about 3 μm or less, about 2 μm or less, about 1 μm or less, 0.8 μm or less, or about 0.5 μm or less. For example, a first sub-group can comprise a maximum initial TTV of 1 μm or less with an overall average initial TTV of 2 μm or less, and a second sub-group can comprise a maximum initial TTV of 2 μm or less with an overall average initial TTV of from 2 μm to 5 μm. Sorting the plurality of sheets into groups and/or sub-groups based on average sheet thickness and/or TTV can increase yield and throughput because samples with similar initial average sheet thicknesses need to be etched a similar amount, meaning that a batch etching will produce a high yield of sheets comprising a final average sheet thickness within a predefined range and/or a final TTV within a second predefined range.

In some embodiments, the groups and/or sub-groups can correspond to positions across a width of a glass-based ribbon from which the plurality of glass-based sheets are formed. For example, a first group and/or first sub-group can consist of glass-based sheets corresponding to a central portion of the glass-based ribbon while a second group and/or second sub-group can consist of glass-based sheets corresponding to a first edge of the glass-based ribbon. Without wishing to be bound by theory, a thickness profile along the width of the glass-based ribbon can be relatively constant for different locations along the length of the glass-based ribbon, for example, when the glass-based ribbon is formed in a steady state and/or quasi-steady state condition. Also, the edges of the glass-based ribbon can be thicker than the central portion of the glass-based ribbon. Additionally, when the glass-based ribbon is formed by a fusion down-draw process, a first edge of the glass-based ribbon closer to an inlet of glass-based material can have larger thickness variations than thickness variations of a second edge of the glass-based ribbon opposite the first edge, for example, because variations in a flow rate of glass-based material through the inlet.

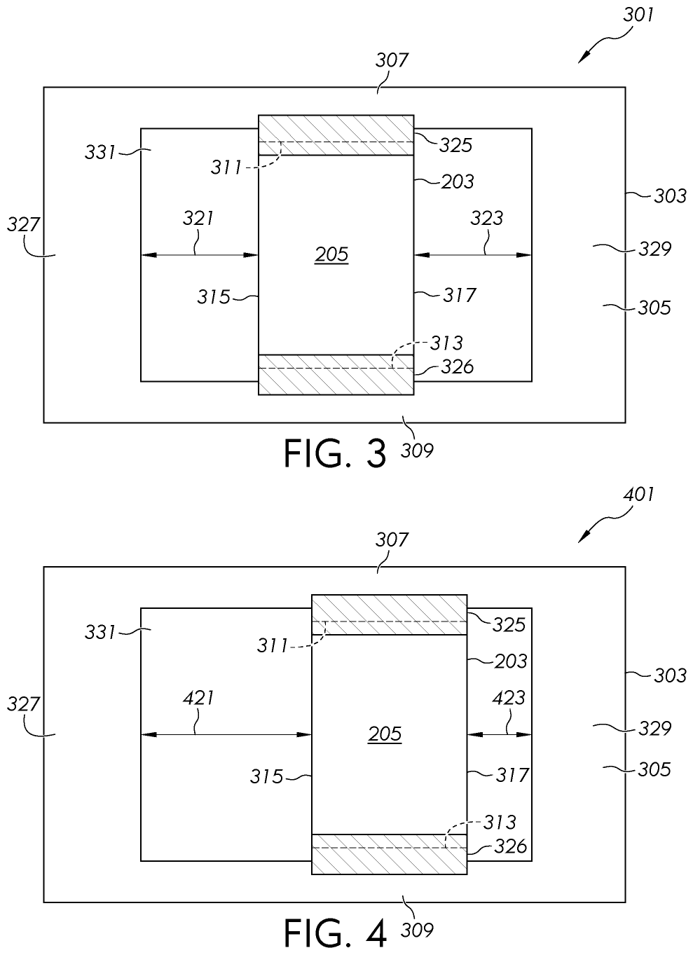

After step 101 or 103, as shown in FIGS. 3-6, the method can proceed to step 105 comprising orienting the glass-based sheet (e.g., each glass-based sheet of the first plurality of sheets and/or each glass-based sheet of the first sub-group) relative to a jig and placing the corresponding glass-based sheet in the jig. In some embodiments, the glass-based sheet can comprise at least for edges defined between the first major surface and the second major surface opposite the first major surface. In some embodiments, orienting the glass-based sheet can comprise determining a first edge 311 of the glass-based sheet. As used herein, a sub-average initial thickness refers to an average of the thickness measurements for points taken within the third of the glass-based sheet of a corresponding edge of the glass-based sheet, wherein the points correspond to points used to determine a TTV. For example, a first sub-average initial thickness refers to an average of thickness measurements of the initial (i.e., before etching) glass-based sheet within the third of the glass-based sheet closest to the first edge 311. In further embodiments, the first edge 311 is determined as the edge comprising the greatest corresponding sub-average initial thickness. Consequently, the first sub-average initial thickness is greater than a corresponding sub-average initial thickness of other edges of the glass-based sheet. In further embodiments, a second edge 313 is determined as the edge opposite the first edge 311. In even further embodiments, the orienting can further comprise determining a third edge 315 of the glass-based sheet as the edge comprising a third sub-average initial thickness greater than a fourth sub-average initial thickness of a fourth edge 317 with the fourth edge 317 opposite the third edge 315.

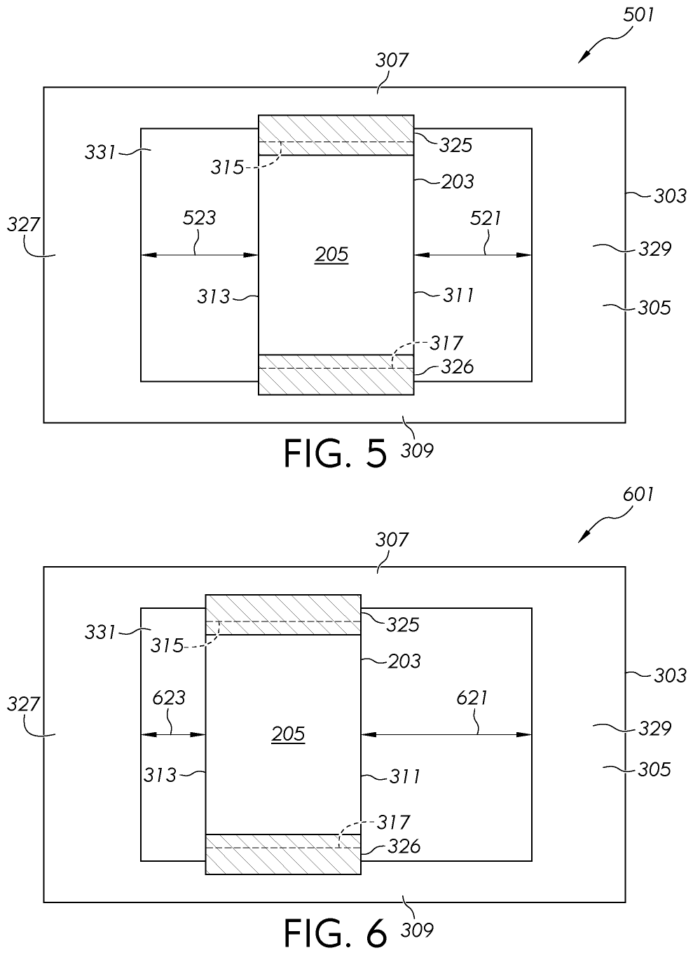

In some embodiments, as shown in FIGS. 3-4, the orienting and the placing of step 105 can further comprise placing the first edge 311 closest to a top side 307 of the jig 303. As shown, the jig 303 comprises a perimeter support 305 with the top side 307 and a bottom side 309 opposite the top side 307 with a first side 327 and a second side 329 extending between the top side 307 and the bottom side 309. As used in reference to the sides of the jig, “top” and “bottom” refer to the orientation of the jig during the etching process described below with reference to FIGS. 5-6. In further embodiments, as shown, the second edge 313 of the glass-based sheet 203 can be closest to the bottom side 309 of the jig. In further embodiments, as shown in FIGS. 3-4, a first distance 321 or 421 can be defined between the third edge 315 of the glass-based sheet 203 and the first side 327 of the perimeter support 305 of the jig 303, and a second distance 323 or 423 can be defined between the fourth edge 317 of the glass-based sheet 203 and the second side 329 of the perimeter support 305 of the jig 303. In even further embodiments, as shown in FIG. 3, the first distance 321 and the second distance 323 can be substantially equal. As used herein, distance from the perimeter support of the jig refers to shorter of the distance to the first side of the jig or the second edge of the jig, which excludes the top side of the jig and the bottom side of the jig. In still further embodiments, as shown in FIG. 3, the glass-sheet can be substantially centered in an interior area 331 of the jig 303 defined by the perimeter support 305. In still further embodiments, the glass-based sheet can be positioned as shown in FIG. 3 when a difference between the third sub-average initial thickness and the fourth sub-average initial thickness is not greater than a predefined thickness threshold. In yet further embodiments, the predefined thickness threshold can be about 1 μm or more, about 1.5 μm or more, about 2 μm or more, about 2.5 μm or more, or about 3 μm or more. In yest further embodiments, the predefined thickness threshold as a percentage of the TTV of the glass-based sheet can be about 50% or more, about 75% or more, about 85% or more, or about 90% or more. In even further embodiments, as shown in FIG. 4, the first distance 421 can be greater than the second distance 423 such that the fourth edge 317 is closer to the perimeter support 305 (e.g., second side 329) than the third edge 315 is to the perimeter support 305 (e.g., first side 327). In still further embodiments, as shown in FIG. 4, the glass-sheet can be off-center in an interior area 331 of the jig 303 defined by the perimeter support 305. In still further embodiments, the glass-based sheet 203 can be positioned as shown in FIG. 4 when a difference between the third sub-average initial thickness and the fourth sub-average initial thickness is greater than a predefined thickness threshold, which can be within one or more of the ranges discussed above for the predefined thickness threshold. In even further embodiments, as shown in FIGS. 3-4, a distance between the first edge 311 and the second edge 313 can be greater than a distance between the third edge 315 and the fourth edge 317. In even further embodiments, although not shown, a distance between the first edge 311 and the second edge 313 can be less than or equal to a distance between the third edge 315 and the fourth edge 317. In some embodiments, the first distance 321, 421, 521, and/or 621 and/or the second distance 323, 423, 523, and/or 623 can be about 1 mm or more, 2 mm or more, about 3 mm or more, about 5 mm or more, about 50 mm or less, about 30 mm or less, about 20 mm or less, about 15 mm or less, or about 10 mm or less. In some embodiments, the first distance 321, 421, 521, and/or 621 and/or the second distance 323, 423, 523, and/or 623 can be in a range from about 1 mm to about 50 mm, from about 1 mm to about 30 mm, from about 2 mm to about 30 mm, from about 2 mm to about 20 mm, from about 3 mm to about 20 mm, from about 3 mm to about 15 mm, from about 5 mm to about 15 mm, from about 5 mm to about 10 mm, or any range or subrange therebetween. In some embodiments, the first distance 321, 421, 521, and/or 621 and/or the second distance 323, 423, 523, and/or 623 can be about 5 mm or less, for example, in a range from about 1 mm to about 5 mm, from about 1 mm to about 3 mm, from about 2 mm to about 5 mm, from about 3 mm to about 5 mm, or any range or subrange therebetween. In some embodiments, the first distance 321, 421, 521, and/or 621 and/or the second distance 323, 423, 523, and/or 623 can be obtained by modifying an existing jig by extending a portion of the perimeter support into the interior area, for example, by taping over a portion of the interior area.

In some embodiments, as shown in FIGS. 5-6, the orienting and the placing of step 105 can further comprise placing the third edge 315 closest to a top side 307 of the jig 303. In further embodiments, as shown, the fourth edge 317 of the glass-based sheet 203 can be closest to the bottom side 309 of the jig. In further embodiments, as shown in FIGS. 5-6, a first distance 521 or 621 can be defined between the first edge 311 of the glass-based sheet 203 and the second side 329 of the perimeter support 305 of the jig 303, and a second distance 523 or 623 can be defined between the second edge 313 of the glass-based sheet 203 and the first side 327 of the perimeter support 305 of the jig 303. In even further embodiments, as shown in FIG. 5, the first distance 521 and the second distance 523 can be substantially equal. In still further embodiments, as shown in FIG. 5, the glass-sheet can be substantially centered in an interior area 331 of the jig 303 defined by the perimeter support 305. In even further embodiments, the glass-based sheet can be positioned as shown in FIGS. 5-6 when a difference between the first sub-average initial thickness and the second sub-average initial thickness is not greater than a predefined thickness threshold, which can be within one or more of the ranges discussed above for the predefined thickness threshold. In even further embodiments, as shown in FIG. 6, the first distance 621 can be greater than the second distance 623 such that the second edge 313 is closer to the perimeter support 305 (e.g., first side 327) than the first edge 311 is to the perimeter support 305 (e.g., second side 329). In still further embodiments, as shown in FIG. 6, the glass-sheet can be off-center in an interior area 331 of the jig 303 defined by the perimeter support 305. In still further embodiments, the glass-based sheet 203 can be positioned as shown in FIG. 6 when a difference between the first sub-average initial thickness and the second sub-average initial thickness is greater than a predefined thickness threshold, which can be within one or more of the ranges discussed above for the predefined thickness threshold. In even further embodiments, as shown in FIGS. 5-6, a distance between the first edge 311 and the second edge 313 can be less than or equal to a distance between the third edge 315 and the fourth edge. In even further embodiments, although not shown, a distance between the first edge 311 and the second edge 313 can be greater than a distance between the third edge 315 and the fourth edge 317.

Orienting at least one glass-based sheet so that a sub-average thickness of an edge (e.g., first edge or third edge) closest to the top side of the jig is greater than an another sub-average thickness of an another edge (e.g., second edge or fourth edge) opposite the edge can reduce a difference between these sub-average thicknesses and/or a TTV of the sheet in a vertical top spray etching process because the portion (e.g., edge) of the glass-based sheet closest to the top side of the jig can be etched faster than the another edge of the glass-based sheet. Placing an edge (e.g., fourth edge) of a glass-based sheet closer to a perimeter support (e.g., second side) than an another edge (e.g., third edge) of the based sheet is to the perimeter support (e.g., second side) with a sub-average thickness (e.g., fourth sub-average thickness) of the edge less than an another sub-average thickness (e.g., third sub-average thickness) of the another edge can reduce a difference between these sub-average thicknesses and/or a TTV of the sheet (e.g., in a vertical top spray etching process) because the edge closer to the perimeter support can be partially shielded from the etchant, which can reduce an effective etch rate of the corresponding edge of the glass-based sheet.

In some embodiments, as shown in FIGS. 3-6, the placing of step 105 can further comprise securing the glass-based sheet 203 in the jig 303. In further embodiments, as shown in FIGS. 3-4, the glass-based sheet 203 can be secured by placing a first piece of tape 325 extending between and at least partially covering the first edge 311 of the glass-based sheet 203 and the top side 307 of the jig 303. In even further embodiments, as shown in FIGS. 3-4, the glass-based sheet 203 can be further secured by placing a second piece of tape 326 extending between and at least partially covering the second edge 313 of the glass-based sheet 203 and the bottom side 309 of the jig 303. In further embodiments, as shown in FIGS. 5-6, the glass-based sheet 203 can be secured by placing a first piece of tape 325 extending between and at least partially covering the third edge 315 of the glass-based sheet 203 and the top side 307 of the jig 303. In even further embodiments, as shown in FIGS. 5-6, the glass-based sheet 203 can be further secured by placing a second piece of tape 326 extending between and at least partially covering the fourth edge 317 of the glass-based sheet 203 and the bottom side 309 of the jig 303. Consequently, the glass-based sheet 203 and the jig 303 can be combined to form the cassette 301, 401, 501, or 601 shown in FIGS. 3-6. In further embodiments, the first major surface 205 and the second major surface (not shown) can be exposed (i.e., substantially all of the overall area of the corresponding major surface is not covered by tape and/or the jig). In some embodiments, the jig 303 and/or the tape 325 and/or 326 can comprise an acid-resistant material. Exemplary embodiments of acid-resistant materials include polymers, for example, polyethylene, polypropylene, polycarbonate (PC), a halide-containing polymer (e.g., polyvinylchloride (PVC) or a fluorine-containing polymer), polydicyclopentadiene (PDCPD), and polyether ether ketone (PEEK). Example embodiments of fluorine-containing polymers include polytetrafluoroethylene (PTFE), polyvinylfluoride (PVF), polyvinylidene fluoride (PVDF), perfluoropolyether (PFPE), a perfluoroalkoxy (PFA), fluorinated ethylene propylene (FEP) polymers, and ethylene tetrafluoro ethylene (ETFE) polymers.

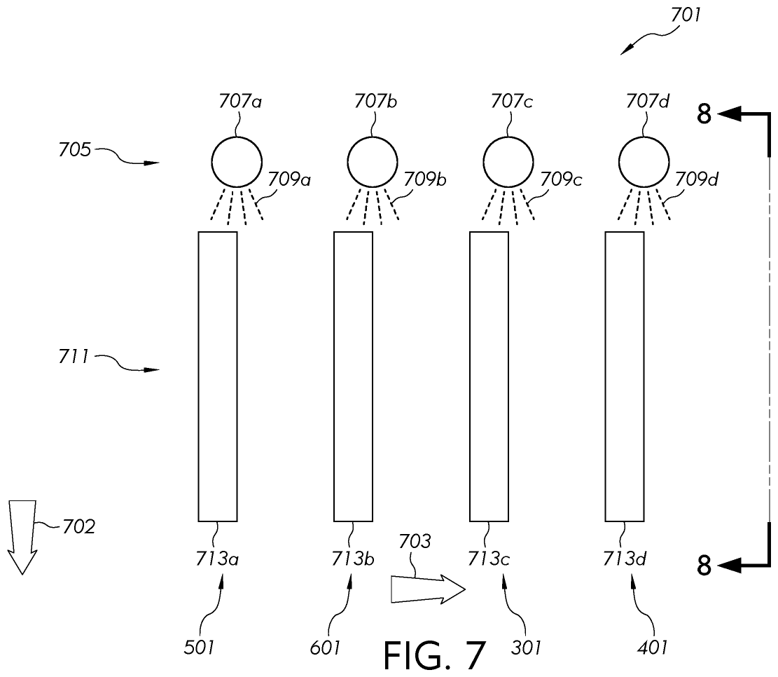

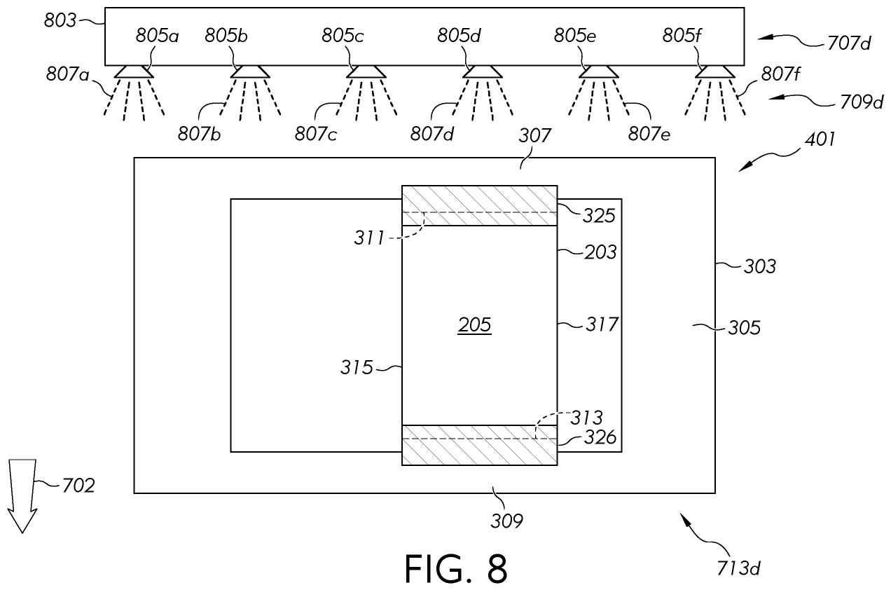

After step 105, as shown in FIGS. 7-8, methods can proceed to step 107 comprising batch etching the glass-based sheet, etching the a plurality of sheets comprising a group of the plurality of groups, and/or etching the glass-based sheets of a sub-group of the plurality of sub-groups. As used herein, batch etching refers to etching a plurality of glass-based sheets simultaneously or at substantially the same time. For example, batch etching includes exposing a plurality of glass-based sheets each placed (e.g., secured) in a corresponding jig to an etchant such that more than one glass-based sheet of the plurality of glass-based sheets is exposed to the etchant simultaneously for at least a majority of the time during the batch etching.

In some embodiments, the etching can comprise immersing the glass-based sheets in a bath of etchant, rolling etchant onto the major surface of the glass-based sheets with a roller (e.g., porous roller, sponge roller), and/or spraying the glass-based sheets with etchant from a nozzle. In further embodiments, the etching comprises vertical top spray etching. FIGS. 7-8 illustrate etching the glass-based sheet as part of a cassette 301, 401, 501, and/or 601 in a vertical top spray apparatus 701 as part of a vertical top spray etching process. As used herein, the “vertical” in “vertical top spray etching refers to the orientation of the glass-based sheet in the jig being vertical, meaning that the first major surface is substantially in the direction of gravity such that the top side of the jig is at a higher elevation than the bottom side of the jig. For example, with reference to FIG. 8, the glass-based sheet 203 is vertically oriented because the first major surface 205 of the glass-based sheet 203 extends substantially in a direction 702 of gravity (e.g., extends in the direction of gravity). Further, FIG. 8 shows that the top side 307 of the jig 303 is at a higher elevation than the bottom side 309 of the jig 303 with the corresponding first edge 311 of the glass-based sheet 203 at a higher elevation than the second edge 313 of the glass-based sheet 203. As used herein “top spray” in “vertical top spray etching” means that the nozzles are positioned above the glass-based sheet and the jig such that the nozzle spray etchant that travels downward to reach the glass-based sheet being etched. For example, as shown in FIGS. 7-8, the plurality of nozzles 705 are positioned above the cassettes 301, 401, 501, and/or 601 comprising the glass-based sheet and the jig such that an etchant spray 709a-d and/or 807a-f of the etchant sprayed from the nozzles 707a-d and/or 805a-f of the plurality of nozzles 705 travels in downward to reach the cassettes 301, 401, 501, and/or 601 containing the glass-based sheet being etched. In some embodiments, as shown in FIG. 8, the plurality of nozzles can further comprise a column of nozzles 707d comprising a plurality of nozzles 805a-f extending a direction perpendicular to the direction 703 and the direction 702 of gravity. For example, nozzle 709d of the plurality of nozzle 705 in FIG. 7 can correspond to the column (e.g., plurality) of nozzles 805a-f shown in FIG. 8. In further embodiments, as shown, the plurality of nozzles 705 can comprise nozzles 707a-d arranged in a row extending in the direction 703. In still further embodiments, the column of nozzles 707d can extend across a width of the cassette (e.g., jig, glass-based sheet), which can be attached to a bar 803 extending above the nozzles. In further embodiments, each nozzle 707a-d and/or 805a-f can be configured to emit (e.g., emit) a corresponding etchant spray 709a-d and/or 807a-f with a spread relative to the direction 702 of gravity of about 60° or less, about 45° or less, or about 30° or less. In some embodiments, as shown in FIG. 7, the plurality of cassettes 711 comprising cassettes 713a-d containing a corresponding plurality of glass-based sheets being etched in the batch etching can travel in a direction 703. As discussed above, both the first major surface 205 and the second major surface (not shown) of the glass-based sheet in the cassette (e.g., cassette 713d) can be exposed to the etchant sprayed from the nozzles. Etching both major surfaces of the glass-based sheet (e.g., in vertical top spray etching) can increase throughput relative to single side etching by increasing (e.g., doubling) an effective etch rate. Etching both major surfaces of the glass-based sheet (e.g., in vertical top spray etching) can reduce (e.g., avoid) warp of the sheet during etching and/or in subsequent properties by removing substantially equal amounts of material from both major surfaces. Etching both major surfaces of the glass-based sheet (e.g., in vertical top spray etching) can produce a sheet with substantially uniform surface properties (e.g., composition) since material is removed from both side of the glass-based sheet (e.g., removing a surface layer that can comprise a different composition than a core layer).

In some embodiments, the etchant can comprise fluorine, for example, as hydrofluoric acid, ammonium fluoride, and/or ammonium bifluoride. In some embodiments, the etchant can comprise one or more mineral acids, for example, hydrofluoric acid, nitric acid, hydrochloric acid, phosphoric acid, and/or sulfuric acid. In some embodiments, the etching can comprise an etch rate at which an average sheet thickness of the glass-based sheet decreases. In further embodiments, the etch rate can be about 0.5 micrometers per minute (μm/min) or more, about 1 μm/min or more, about 1.5 μm/min or more, about 3.5 μm/min or less, about 3 μm/min or less, about 2.5 μm/min or less, or about 2 μm/min or less. In further embodiments, the etch rate can be in a range from about 0.5 μm/min to about 3.5 μm/min, from about 0.5 μm/min to about 3 μm/min, from about 1 μm/min to about 3 μm/min, from about 1 μm/min to about 2.5 μm/min, from about 1.5 μm/min to about 2.5 μm/min, from about 1.5 μm/min to about 2 μm/min, from about 1 μm/min to about 2 μm/min, or any range or subrange therebetween. Based of the etch rate, the initial thickness, and the intended final thickness, an appropriate etching time can be selected. Providing a low etch rate (e.g., about 3 micrometers per minute (μm/min) or less, about 2.5 μm/min or less, about 2 μm/min or less) can increase a yield of sheets relative to a higher etch rate because an incidence of defects can be reduced. Providing a sufficiently high etch rate (e.g., about 0.5 μm/min or more, about 1 μm or more) can increase a throughput of methods because glass-based sheet can be etched faster than if a lower etch rate was used without a significant increase in defects. Providing a vertical top spray etch process for etching (e.g., batch etching) the sheet(s) can increase an effective etch rate of an etchant, for example, by replacing existing etchant with new etchant by spraying the etchant and by removing existing etchant and/or etching byproduct through a flow of etchant in the direction of gravity along the sheet.

In some embodiments, step 107 can further comprise rinsing the glass-based sheet (e.g., plurality of sheets) to remove the etchant and byproducts thereof, for example, using deionized water and/or a detergent solution. In further embodiments, the glass-based sheet can be dried by blowing a gas across the major surfaces of the glass-based sheet, for example, using a blower and/or air knife drying. In some embodiments, step 107 can further comprise removing the glass-based sheet (e.g., plurality of sheets) from the corresponding jig. In further embodiments, the removing the glass-based sheet can comprise cutting a central portion of the glass-based sheet from the corresponding cassette containing the jig, for example, using a laser to separate peripheral portions of the glass-based sheet with uneven thickness and/or defects (e.g., as a result of contact with the jig and/or the pieces of tape).

In some embodiments, the etching can reduce the initial average sheet thickness of the glass-based sheet to the final average sheet thickness. In further embodiments, a difference between the initial average sheet thickness and the final average sheet thickness can be about 10 μm or more, about 30 μm or more, about 50 μm or more, about 70 μm or more, about 100 μm or more, about 1 mm or less, about 600 μm or less, or about 300 μm or less. In further embodiments, a difference between the initial average sheet thickness and the final average sheet thickness can be in a range from about 10 μm to about 1 mm, from about 30 μm to about 1 mm, from about 50 μm to about 1 mm, from about 50 μm to about 600 μm, from about 100 μm to about 600 μm, from about 100 μm to about 300 μm, or any range or subrange therebetween. In further embodiments, after the etching, the glass-based sheet can comprise a final TTV that can be less than or equal to the initial TTV. In further embodiments, after the etching, the glass-based sheet can comprise sub-average final thicknesses at the corresponding edges of the glass-based sheet. In even further embodiments, a difference between the first sub-average initial thickness and a second sub-average initial thickness of the second edge can be greater than a difference between a first sub-average final thickness of the first edge and a second sub-average final thickness of the second edge, meaning that the difference in sub-average thicknesses decreased as a result of the etching (e.g., placing the first edge closest to the top side of the jig). In even further embodiments, a difference between the third sub-average initial thickness and the fourth sub-average initial thickness can be greater than a difference between a third sub-average final thickness of the third edge and a fourth sub-average final thickness of the fourth edge, meaning that the difference in sub-average thicknesses decreased as a result of the etching (e.g., placing the fourth edge closer to the second side of the perimeter wall than the third edge is to the first side of the perimeter wall).

In some embodiments, the etching a plurality of sheets (e.g., plurality of sheets of a group of the plurality of groups, plurality of sheets of a sub-group of the plurality of sub-groups) can reduce an overall average initial sheet thickness to an overall average final sheet thickness, which can be within one or more of the ranges discussed above for the difference between the initial average sheet thickness and the final average sheet thickness. In further embodiments, a group and/or a sub-group can comprise a maximum difference between a first final average sheet thickness of the first sheet and a second final average sheet thickness of the second sheet of the first plurality of sheets is less than or equal to the predefined threshold (discussed above), for example, if the spread of the average sheet thicknesses did not increase during the etching or increased by an acceptable amount during the etching. In further embodiments, for at least one glass sheet, a final TTV can be less than an initial TTV. In even further embodiments, a maximum final TTV of the sub-group of the plurality of sub-groups can be less than or equal to the maximum initial TTV of the sub-group. In further embodiments, after the etching for at least one glass-based sheet, the at least one glass-based sheet can comprise sub-average final thicknesses at the corresponding edges of the at least one glass-based sheet. In even further embodiments, a difference between the first sub-average initial thickness and a second sub-average initial thickness of the second edge can be greater than a difference between a first sub-average final thickness of the first edge and a second sub-average final thickness of the second edge of the at least one glass-based sheet, meaning that the difference in sub-average thicknesses decreased as a result of the etching (e.g., placing the first edge closest to the top side of the jig). In even further embodiments, a difference between the third sub-average initial thickness and the fourth sub-average initial thickness can be greater than a difference between a third sub-average final thickness of the third edge and a fourth sub-average final thickness of the fourth edge of the at least one glass-based sheet, meaning that the difference in sub-average thicknesses decreased as a result of the etching (e.g., placing the fourth edge closer to the second side of the perimeter wall than the third edge is to the first side of the perimeter wall).

After step 107, methods can proceed to step 109 comprising subsequent processing of the glass-based ribbon. In some embodiments, step 109 can comprise chemically strengthening the glass-based substrate, further etching the glass-based substrate, and/or grinding and/or polishing the edges of the glass-based substrate. In some embodiments, step 109 can comprise incorporating the glass-based substrate into a device (e.g., consumer electronic device), for example, using an adhesive.

After steps 107 and/or 109, the method can be complete at step 111. In some embodiments, methods of making a foldable apparatus in accordance with embodiments of the disclosure can proceed along steps 101, 103, 105, 107, 109, and 111 of the flow chart in FIG. 1 sequentially, as discussed above. In some embodiments, as shown in FIG. 1, arrow 102 can be followed from step 101 to step 105, omitting step 103, for example, when the plurality of glass-based sheets are not to be grouped. In some embodiments, arrow 104 can be followed from step 103 to step 107, omitting step 105, for example, if the glass-based sheets are not to be oriented (e.g., a difference in sub-average thicknesses is small). In some embodiments, arrow 106 can be followed from step 107 to step 111, for example if the method produces the final glass-based sheet(s) at the end of step 107. Any of the above options may be combined to make a foldable apparatus in accordance with embodiments of the disclosure.

### Examples

Various embodiments will be further clarified by the following examples. Examples A-B and the data reported in Tables 1-3 use a glass-based sheet (having a Composition 1 of, nominally, in mol % of: 69.1 SiO₂; 10.2 Al₂O₃; 15.1 Na₂O; 0.01 K₂O; 5.5 MgO; 0.09 SnO₂) cut from a glass-based ribbon formed using a fusion down-draw method with a nominal average thickness of 300 μm. For the data reported in Tables 1-3, the glass-based sheets were etched to achieve a nominal final average sheet thickness of 33 μm. Examples A-B were etched with an etch rate of 2.0 μm/min. For the data in Table 1, glass-based sheets were placed into groups randomly.

Table 1 presents the effect of sorting glass-based sheets into groups on the final TTV of the glass-based sheets and, consequently, the yield of the batch etching process. For the data presented in Table 1, yield was determined based on the percentage of glass-based sheets comprising a final TTV of 3 μm or less. In the “no sorting” condition, glass-based sheets were taken sequentially as they were separated from a glass-based ribbon. In the “sorting into groups” condition, the glass-based sheets were sorted into groups based on their position along the width of the glass-based ribbon from which they were separated. As discussed above, there is variation across the width of the glass ribbon from which the glass-based were separated, which contributes to variation between glass-based sheets in average thickness and TTV of the glass-based sheets. Consequently, the “sorting into groups” condition amounts to sorting based on average thickness and/or TTV. As shown in Table 1, the yield of the batch etching process increased from 37% to 52% (40% relative increase) by sorting the glass-based sheets into groups rather than taking glass-based sheets as they are separated from the glass-based ribbon.

TABLE 1
Effect of Sorting into Groups

| | No Sorting | Sorting into Groups |
|---|---|---|
| Yield (%) | 37 | 52 |

Table 2 presents the effect of etch rate on the yield and defect rates of glass-based sheets formed by batch etching in a vertical top-spray etching process. As used herein, Moire defects refer to local region on the glass-based sheet comprising a thickness at least 70 nm lower than the surround region and is visible as a different color and/or a striped pattern under polarized light. Without wishing to be bound by theory, Moire defects can be formed by etchant not completely removed at the end of the etching process. As shown in Table 2, decreasing the etch rate from 6 μm/min to 3.5 μm/min decreases an incidence of Moire defects from 17% to 7%. Further decreasing the etching rate from 3.5 μm/min to 2 μm/min decreases an incidence of Moire defects from 7% to 2%. For a decrease of 1.5 μm/min from 3.5 μm/min to 2 μm/min, the rate of Moire defects is cut by over 70%. Likewise, decreasing the etching rate from 6 μm/min to 3.5 μm/min decreases the fraction of sheets with a final TTV>10 μm from 10% to 5%. Further decreasing the etching rate from 3.5 μm/min to 2 μm/min decreases the fraction of sheets with a final TTV>10 μm from 8% to 5%. As used herein, an overall yield refers to the percentage of glass-based sheets meeting all requirements, including an absence of defects, final TTV<10 μm, and final average sheet thickness within 1 μm of 33 μm. An overall yield increased from 24% to 36% by decreasing the etching rate from 6 μm/min to 3.5 μm/min. Further decreasing the etch rate from 3.5 μm/min to 2.0 μm/min increased the overall yield from 36% to 50%. Indeed, the increase in overall yield going from 3.5 μm/min to 2 μm/min is greater than going from 6 μm/min to 3.5 μm/min (absolute increases of 14% versus 12% overall yield). The extent to which the yield increases and the incidence of Moire defects decreases is unexpected.

TABLE 2
Effect of Etch Rate

| Etch Rate | Moire | TTV > | Overall |
|---|---|---|---|
| (μm/min) | Defect (%) | 10 μm (%) | Yield (%) |
| 6.0 | 17 | 10 | 24 |
| 3.5 | 7 | 8 | 36 |
| 2.0 | 2 | 5 | 50 |

Table 3 presents properties of glass-based sheets in Examples A-B. In Example A, the glass-based sheet was always centered in the jig and randomly oriented with regards to sub-average thickness. In Example B, the glass-based sheet was oriented so that top edge sub-average thickness was greater than the bottom edge sub-average thickness. In Example B, the glass-based sheet was always placed so that the left edge was closer to the perimeter support than the right edge was to the perimeter support; and the left edge sub-average thickness was less than or equal to the right edge sub-average thickness.

TABLE 3
Effect of Orienting Glass-based Sheet

| Example | A | B |
|---|---|---|
| Top Edge | 301.5 | 302.0 |
| Sub-average | | |
| Thickness (μm) | | |
| Bottom Edge | 301.9 | 299.8 |
| Sub-average | | |
| Thickness (μm) | | |
| Right Edge | 301.7 | 303.1 |
| Sub-average | | |
| Thickness (μm) | | |
| Left Edge | 302.6 | 301.9 |
| Sub-average | | |
| Thickness (μm) | | |
| Initial TTV (μm) | 1.9 | 2.1 |
| Final TTV (μm) | 3.2 | 2.0 |

Example A comprised a glass-based sheet where the first distance between a right edge and the perimeter support was equal to the second distance between the left edge and the perimeter support. However, the top edge (edge closest to the top side of the jig) comprises a corresponding sub-average thickness 0.4 μm less than the bottom edge sub-average thickness of the bottom edge (opposite the top edge). The difference between the sub-average thickness of the right edge and the left edge was 0.9 μm. Etching the glass-based sheet for Example A produced a glass-based sheet with an average sheet thickness of 33.4 μm and increased the TTV from 1.9 μm to 3.2 μm.

In Example B, the glass-based sheet was positioned such that the left edge was closer to the perimeter support (first side) than the right edge was to the perimeter support (second side). In Example B, the right edge sub-average thickness is less than the right edge sub-average thickness by 1.2 μm. The top edge sub-average thickness is greater than the bottom edge sub-average thickness by 2.2 μm. Etching the glass-based sheet for Example B produced a glass-based sheet with an average sheet thickness of 33.4 μm and decreased the TTV from 2.1 μm to 2.0 μm. Consequently, orienting the sheet with a greater distance between the edge with the greater thickness and the perimeter support than the opposite edge and the perimeter wall was able to decrease TTV.

Averages in etch rate for the different edge regions (e.g., corresponding to edge sub-average thicknesses) were calculated for the glass-based sheets batch etched in Example B. An average difference in the etching rate for the top edge sub-average is greater than the etching rate for the bottom edge sub-average by 0.02 μm/min. An average difference in the etching rate for the side with the longer distance to the perimeter support (e.g., right edge sub-average thickness) and the side with the shorter distance to the perimeter support (e.g., left edge sub-average thickness) is 0.01 μm/min. For example, removing an average of 270 μm (e.g., going from an overall initial average sheet thickness of about 300 μm to an overall final average sheet thickness of about 30 μm) at a rate of 2.0 μm/min on each surface (e.g., first major surface, second major surface) can take about 67.5 minutes during which a difference between the top edge sub-average thickness and the bottom edge sub-average thickness of about 1.35 μm can be corrected by orienting the glass-based sheet as discussed above. In other situations, where there is a small difference between the top edge sub-average thickness and the bottom edge sub-average thickness, the orientation of the glass-based sheet can be flipped partway through the batch etching process, for example, by flipping the entire cassette including the jig and the glass-based sheet. Likewise, removing an average of 270 μm at a rate of 2.0 μm/min on each surface with one edge of the glass-based sheet closer to the perimeter support than the other can reduce a difference in sub-average thicknesses by about 0.68 μm. On the other hand, the sub-average thickness is expected to the same for the right edge and the left edge when the corresponding edges are equidistant from the perimeter support. Consequently, orienting glass-based sheets based on the corresponding sub-average thicknesses can reduce thickness variation (e.g., TTV) across the glass-based sheet during the batch etching process.

The above observations can be combined to provide methods of etching a glass-based sheet and/or etching a plurality of glass-based sheets that can produce a high yield of glass-based sheets with low defects, low TTV, and high uniformity in thickness across sheets of the plurality of glass-based sheets in a high-throughput, batch etching process. For example, sorting the plurality of sheets into groups and/or sub-groups based on average sheet thickness and/or TTV can increase yield and throughput because samples with similar initial average sheet thicknesses need to be etched a similar amount, meaning that a batch etching will produce a high yield of sheets comprising a final average sheet thickness within a predefined range and/or a final TTV within a second predefined range. Orienting at least one glass-based sheet so that a sub-average thickness of an edge (e.g., first edge or third edge) closest to the top side of the jig is greater than an another sub-average thickness of an another edge (e.g., second edge or fourth edge) opposite the edge can reduce a difference between these sub-average thicknesses and/or a TTV of the sheet in a vertical top spray etching process because the portion (e.g., edge) of the glass-based sheet closest to the top side of the jig can be etched faster than the another edge of the glass-based sheet. Placing an edge (e.g., fourth edge) of a glass-based sheet closer to a perimeter support (e.g., second side) than an another edge (e.g., third edge) of the based sheet is to the perimeter support (e.g., second side) with a sub-average thickness (e.g., fourth sub-average thickness) of the edge less than an another sub-average thickness (e.g., third sub-average thickness) of the another edge can reduce a difference between these sub-average thicknesses and/or a TTV of the sheet (e.g., in a vertical top spray etching process) because the edge closer to the perimeter support can be partially shielded from the etchant, which can reduce an effective etch rate of the corresponding edge of the glass-based sheet. Providing a low etch rate (e.g., about 3 micrometers per minute (μm/min) or less, about 2.5 μm/min or less, about 2 μm/min or less) can increase a yield of sheets relative to a higher etch rate because an incidence of defects can be reduced. Providing a sufficiently high etch rate (e.g., about 0.5 μm/min or more, about 1 μm or more) can increase a throughput of methods because glass-based sheet can be etched faster than if a lower etch rate was used without a significant increase in defects. Providing a vertical top spray etch process for etching (e.g., batch etching) the sheet(s) can increase an effective etch rate of an etchant, for example, by replacing existing etchant with new etchant by spraying the etchant and by removing existing etchant and/or etching byproduct through a flow of etchant in the direction of gravity along the sheet. Etching both major surfaces of the glass-based sheet (e.g., in vertical top spray etching) can increase throughput relative to single side etching by increasing (e.g., doubling) an effective etch rate. Etching both major surfaces of the glass-based sheet (e.g., in vertical top spray etching) can reduce (e.g., avoid) warp of the sheet during etching and/or in subsequent properties by removing substantially equal amounts of material from both major surfaces. Etching both major surfaces of the glass-based sheet (e.g., in vertical top spray etching) can produce a sheet with substantially uniform surface properties (e.g., composition) since material is removed from both side of the glass-based sheet (e.g., removing a surface layer that can comprise a different composition than a core layer).

It will be appreciated that the various disclosed embodiments may involve features, elements, or steps that are described in connection with that embodiment. It will also be appreciated that a feature, element, or step, although described in relation to one embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises embodiments having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. Whether or not a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C. As used herein, the terms “comprising” and “including”, and variations thereof shall be construed as synonymous and open-ended unless otherwise indicated.

The above embodiments, and the features of those embodiments, are exemplary and can be provided alone or in any combination with any one or more features of other embodiments provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the embodiments herein provided they come within the scope of the appended claims and their equivalents.

1. A method of etching a plurality of glass-based sheets comprising:
sorting the plurality of glass-based sheets into a plurality of groups of sheets based on an average sheet thickness of a corresponding glass-based sheet of the plurality of glass-based sheets, wherein a maximum difference between a first average sheet thickness of a first sheet of a first plurality of sheets of a first group of sheets of the plurality of groups and a second average sheet thickness of a second sheet of the first plurality of sheets is less than or equal to a first predefined threshold, and the first plurality of sheets comprises an initial overall average sheet thickness;
sorting the first group of sheets into a plurality of sub-groups based on a total thickness variation (TTV) of a corresponding glass-based sheet of the first group, wherein a maximum initial TTV of a first sub-group of the plurality of sub-groups is less than or equal to a second predefined threshold; and
etching the first sub-group in a batch etching process, wherein, after the etching, a maximum final TTV of the first sub-group is less than or equal to a third predefined threshold and a maximum difference between a first final average sheet thickness of a third sheet of the first sub-group and a second final average sheet thickness of a fourth sheet of the first sub-group is less than or equal to the first predefined threshold, and after the etching, the first plurality of glass-based sheets comprises a final overall average sheet thickness.

2. The method of claim 1, wherein the maximum final TTV is about 10 micrometers or less.

3. The method of claim 1, wherein the maximum final TTV is about 2 micrometers or less.

4. The method of claim 1, wherein the final overall average sheet thickness is in a range from about 25 micrometers to about 250 micrometers.

5. The method of claim 1, wherein a difference between the initial overall average sheet thickness and the final overall average sheet thickness is about 50 micrometers or more.

6. The method of claim 1, wherein an etch rate of the etching is in a range from about 1 micrometer per minute to about 3 micrometers per minute.

7. The method of claim 1, wherein the batch etching process comprises vertical top spray etching.

8. A method of etching a glass-based sheet comprising at least four edges between a first major surface and a second major surface, the method comprising:
determining a first edge of the at least four edges of the glass-based sheet comprising a first sub-average initial thickness greater than a corresponding sub-average initial thickness of other edges of the at least four edges, the first edge opposite a second edge of the at least four edges;
placing the glass-based sheet in a jig comprising a perimeter support, wherein the second edge is closer to the perimeter support than the first edge is to the perimeter support; and
etching the glass-based sheet in a vertical top spray etching process to reduce an initial average sheet thickness of the glass-based sheet to a final average sheet thickness.

9. The method of claim 8, further comprising determining a third edge of the at least four edges of the glass-based sheet comprising a third sub-average initial thickness greater than a fourth sub-average initial thickness of a fourth edge of the at least four edges, wherein the placing the glass-based sheet in the jig further comprises placing the third edge closest to a top side of the jig.

10. The method of claim 9, wherein a difference between the third sub-average initial thickness and the fourth sub-average initial thickness is greater than a difference between a third sub-average final thickness of the third edge and a fourth sub-average final thickness of the fourth edge.

11. The method of claim 8, wherein a final total thickness variation (TTV) is less than an initial TTV.

12. The method of claim 8, wherein a difference between the first sub-average initial thickness and a second sub-average initial thickness of the second edge is greater than a difference between a first sub-average final thickness of the first edge and a second sub-average final thickness of the second edge.

13. The method of claim 8, wherein a maximum final TTV of the glass-based sheet is about 2 micrometers or less.

14. The method of claim 8, wherein the final average sheet thickness is in a range from about 25 micrometers to about 250 micrometers.

15. The method of claim 8, wherein a difference between the initial average sheet thickness and the final average sheet thickness is about 50 micrometers or more.

16. A method of etching a glass-based sheet comprising at least four edges between a first major surface and a second major surface, the method comprising:
determining a first edge of the at least four edges of the glass-based sheet comprising a first sub-average initial thickness greater than a corresponding sub-average initial thickness of other edges of the at least four edges, the first edge opposite a second edge of the at least four edges;
placing the glass-based sheet in a jig comprising a perimeter support, wherein the first edge is closest to a top side of the jig; and
etching the glass-based sheet in a vertical top spray etching process to reduce an initial average sheet thickness of the glass-based sheet to a final average sheet thickness.

17. The method of claim 16, wherein a final total thickness variation (TTV) is less than an initial TTV.

18. The method of claim 16, wherein a difference between the first sub-average initial thickness and a second sub-average initial thickness of the second edge is greater than a difference between a first sub-average final thickness of the first edge and a second sub-average final thickness of the second edge.

19. The method of claim 16, wherein the final average sheet thickness is in a range from about 25 micrometers to about 250 micrometers.

20. The method of claim 16, wherein a difference between the initial average sheet thickness and the final average sheet thickness is about 50 micrometers or more.
